(19) United States
(12) Patent Application Publication
(10) Pub. No.: US 2003/0110099 A1
(43) Pub. Date: Jun. 12, 2003

(54) Virtual wearing of clothes

(75) Inventors: Miroslav Trajkovic, Ossining, NY (US); Srinivas Gutta, Buchanan, NY (US); Vasanth Philomin, Briarcliff Manor, NY (US)

Correspondence Address: PHILIPS ELECTRONICS NORTH AMERICAN CORP, 580 WHITE PLAINS RD, TARRYTOWN, NY, 10591, US

(73) Assignee: Philips Electronics North America Corporation, New York City, NY (US)

(21) Appl. No.: 10/014,229

(22) Filed: Dec. 11, 2001

(51) Int. Cl. G06F 17/60

(52) U.S. Cl. 705/27

(57) ABSTRACT

A system and method for virtual clothes modeling includes a unit s for obtaining a virtual image of a particular shopper, a scanner for scanning an identifying token which identifies predetermined information in a database associated with a first article of clothing, a retrieval unit for retrieving from the database a visual display of the predetermined information first article of clothing corresponding to the identifying token, and

a display for displaying the virtual image the particular shopper and the visual display of the first article of clothing being worn by the particular shopper. A shopper can see how they look with an article of clothing just by scanning the token, which can also be a tag or electronic card. The shopper's image may be previously stored in the database. There is an option to browse through similar and/or complimentary items to see how variations of the selected article would look on the shopper.

### BACKGROUND OF THE INVENTION

1. Field of the Invention

The present invention relates to modeling clothes and retailing. More specifically, the present invention relates to a fitting rooms and virtual modeling.

2. Description of the Related Art

In the prior art, retail shoppers have been forced to try on clothes they are about to purchase, to ensure that they fit. However, another major reason people try on clothes is to see how they look in a particular, color or cut. This is particularly true in the case of formal wear for women and men, where it is not unheard for people to try on several dresses/gowns and/or suits to see how they look wearing a certain color, style, etc. In todays busy world, consumers often do not have time to try on several pieces of clothing, sometimes waiting for an available fitting booth, just to see how a certain color or style looks on him/her.

The alternative to trying on clothes in the store is to purchase them on faith, and take them home for their initial try-on. If the color or style does not look good on the buyer, he/she must make an additional trip back to the store to return the item. This return also costs the retailer money, who must process a credit to a person's charge account, or give them back cash, and then have to restock the item in the store.

There can be a significant amount of handling involved to repackage an item, and for example, in a case such as a man's dress shirt, which is often packaged in plastic with a series of folds and pins placed at specific locations, it may be nearly impossible to repackage it so that the next consumer would consider it new. This in turn, means that the store must sometimes ship these items back to a supplier, which in turn with either repackage the item, or perhaps sell it at a discount because of the loss of packaging.

All of these costs for handling and returns, are borne not only by the individual consumer that had to make a second trip back to a store, but by everyone in the form of increased prices to cover the expenses accompanying the exchange/return of such items.

### SUMMARY OF THE INVENTION

The present invention provides a system and a method for the virtual modeling of clothes. In a broad overview of the invention, the system comprises:

means for obtaining a virtual image of a particular shopper;

means for scanning an identifying token which identifies predetermined information in a database associated with a first article of clothing; and

means for retrieving from the database the predetermined information corresponding to an image of the first article of clothing corresponding to the identifying token.

A method according to the present invention comprises the steps of:

(a) reading an identifying token which is associated with a first article of clothing;

(b) retrieving from a database an image of the first article of clothing corresponding the identifying token read in step (a);

(c) retrieving an image of a person stored in the database; and

(d) displaying a virtual image of the person in step (c) and the first article of clothing as a combination or the image of the person and the first article of clothing.

### DETAILED DESCRIPTION OF THE INVENTION

By way of illustration and not limitation, the following figures and their associated description provide an explanation of certain aspects of a system and method according to the present invention. It is understood by persons of ordinary skill in the art that there are variations to the illustrated system and method which are within the spirit of the invention and the scope of the appended claims, and as such the invention is not limited to the illustrations, which have been provided for explanatory purposes.

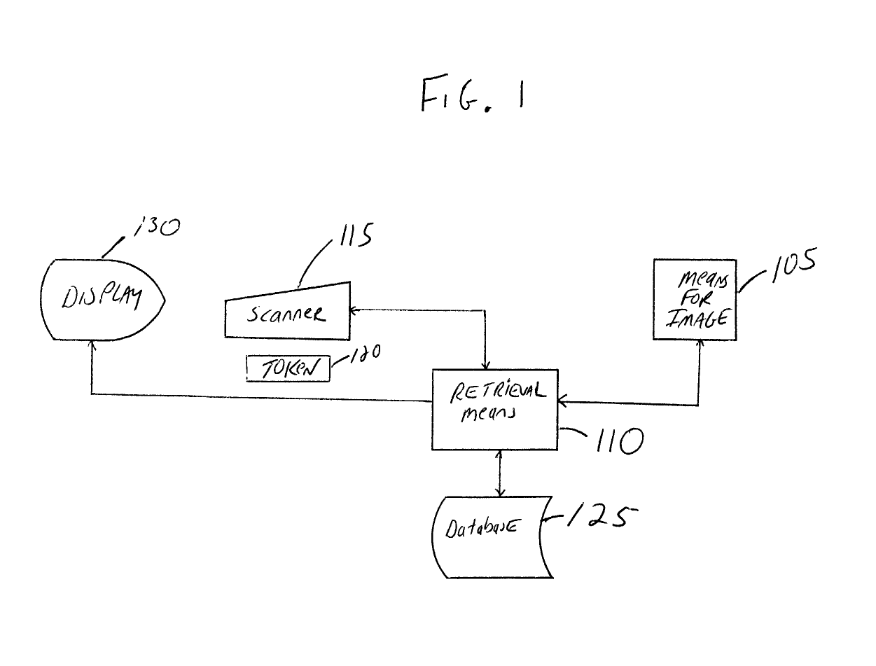

FIG. 1 illustrates an overview of a system according to the present invention.

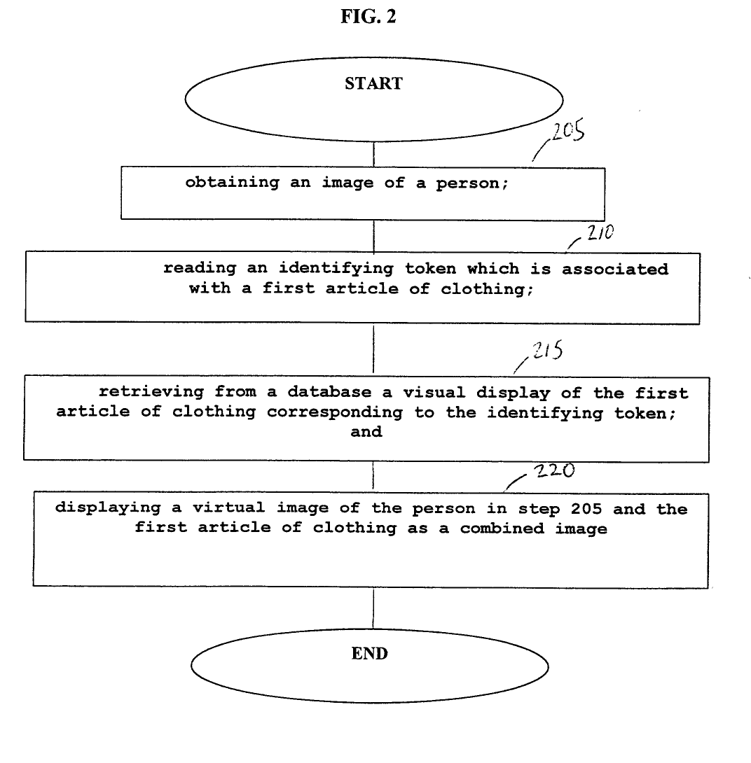

FIG. 2 illustrates a flowchart of a method according to the present invention.

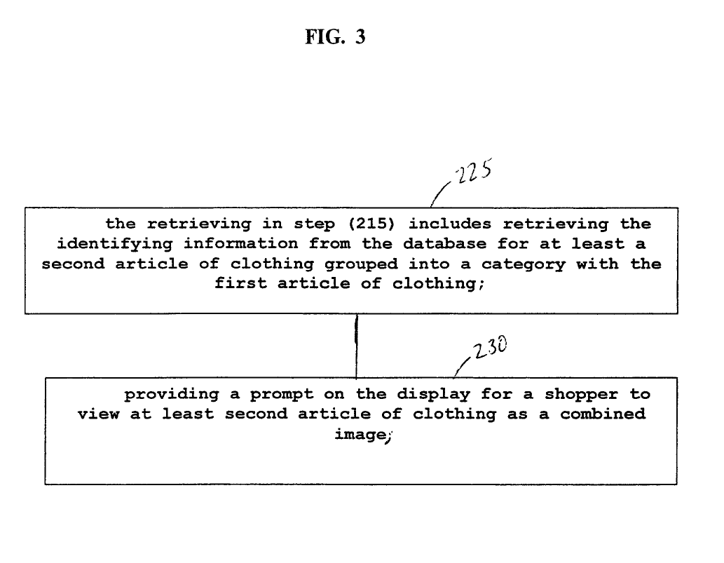

FIG. 3 illustrates an aspect of the method shown in FIG. 2.

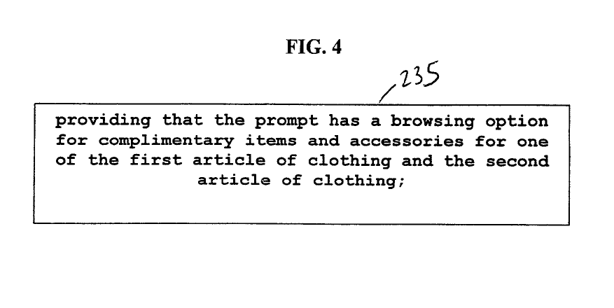

FIG. 4. illustrates an aspect of the method shown in FIG. 3.

### DETAILED DESCRIPTION OF THE PREFERRED EMBODIMENTS

FIG. 1 illustrates a schematic of an embodiment of a system according to the present invention. According to FIG. 1, an image producing means 105, which may be a camera, a person's image is recorded. This image is not limited to any particular type, for example, can be two-dimensional, three dimensional, a still photo, a video sequence, etc. The image could be just the person's face, or of the entire body.

The image will be received by the retrieval means 110, which is part of or in communication with a processor. The retrieval means does not need to be present at the physical location of the image producing means, and any known method of connection, including but not limited to, wire, wireless, fiber optic, LAN, WAN, World Wide Web, etc. can be employed. The image is stored in a storage area (not shown) that can be part of or in communication with the retrieval means.

A scanner 115 also communicates with the retrieval means. The scanner is used for reading an identifying token 120 which is used with the system of the present invention. The scanner is not limited to any particular type, such as magnetic, laser, light emitting diode, etc. The tokens can tags having Universal Product Code (UPC) bar coded labels that are additionally modified to contain additional data regarding an article of clothing. The tokens can also be cards have magnetic or electronic reproducible data stored thereon or therein, and the surfaces of the cards can be read by the scanner, or in the case of electronic storage, could be read by insertion into a scanner which extracts the data from the card.

The tokens can be attached to the article of clothing in any known fashion, such as pinned, clipped, adhered, banded. Conversely, there is no requirement that the tags are connected to the article of clothing. For example, a tag could be displayed next to a certain type of clothing, and the shopper or store employee could bring the tag to the scanner, or bring the scanner to the tag.

In another aspect of the present invention, there can be tokens which are in electronic communication with the retrieval means and/or the scanner, and the shopper may just press actuate a particular tag by, for example, pressing a button, flipping a switch, etc. The particular tag which has been actuated would provide information particular to the article of clothing, or it may merely provide an identification number providing the retrieval means with a particular identifiable file in the database 125 which corresponds to the number on the token.

The information corresponding to the article of clothing identified by the token may be a scanned image of the actual item, so that the color, etc. of the visual display will match the article of clothing. The closer that the colors match between the actual article of clothing and its retrieved image, the more realistic the system will be.

It is to be understood by persons of ordinary skill in the art that there can be variations in color, shape or texture, etc. of clothing according to their time or place of manufacture, so in a best mode it would be preferable for updating of the images in the database with actual items in the store.

The retrieval means will then process the image of the shopper from image producing means 105 and retrieve associated with the identifying token to construct a virtual image. The virtual image can be a composite of the shopper with a display of the clothing that is superimposed over the image of the shopper.

One way that the retrieval means could combine the image of the person and the image of the clothing could be as disclosed in U.S. Pat. No. 6,166,744 to Jaszlics et al., which is hereby incorporated by reference as background material. In Jaszlics, a combined image of a real world object and a masked virtual preferably a high resolution digital monitor, but an analog monitor/display can be used.

Another aspect of the present invention is that the database contains a cross reference of items having similar features. These categories, for example, can be by color, size, shape, texture, manufacturer, designer, size. There can be many other types of categories, and the foregoing are for explanatory purposes. Thus, through either a pointing device, keyboard, keypad, touch screen, etc. the shopper can browse according to different cross referenced categories.

For example, if a shopper had a token identifying a blue pair of paints with a 36 waist and 32 length, there would be an opportunity to browse and select how the viewer would look. For example, the shopper can view pants selected from the same manufacture, except that they can view an image of themself with a pair of the pants if there were pleated, or cuffed, or a different color, or denim, or corduroy, or shorts. The shopper can check for other manufacturer's of similar colors, styles, sizes, shapes (for example, full cut, regular, tapered). When the shopper selected a different article from the one originally scanned, the retrieval means would create a new combined image of the shopper and the second or subsequently selected article of clothing.

Thus by scanning the information for only one article of clothing, a shopper could see how they look in many different styles.

In addition, the database can cross-reference complimentary items, such as matching shirts, shoes, handbags, belts, etc. With each item, the shopper could view themselves with variations of the complimentary item. For example, the display may show a composite image of the shopper with selected pants, and different shirts, shoes, ties, even jewelry. Thus, the time needed to try all these items on, or hold a shirt of one color next to a pair of pants which is another color to see how the items match, can be performed far more efficiently, and provide greater latitude for the shopper.

FIG. 2 provides a flowchart for a method according to the present invention. It is understood by persons or ordinary skill in the art that while in the method according to the present invention provided for explanatory purposes, the image of person shopping is obtained before the identifying token is read, the order of the two steps is interchangeable. In either case, the image of either the person or the item will be retrieved combined as a virtual image.

At step 205, an image is obtained of a shopper. It should be noted that the image does not have to be obtained each time that there is a virtual modeling, and the image may already be stored in a database.

At step 210, an identifying token is read. The identifying token contains information about an associated article of clothing, jewelry, footwear, sleepwear, etc. The identifying token may actually store the information, or it may just be an identifier which a retrieval means uses to locate the associated information.

As previously discussed with regard to the system, it is also contemplated in the present method that the token can be of any known type, such as a bar coded label, ink seal, or a card which has electronic or magnetic storage.

At step 215, the image information regarding the article is retrieved from a database. It is contemplated in one aspect of the invention that these images may have been previously scanned into the system and stored in the database. In another aspect of the invention, cross-referenced information, and/or categorized information which the particular article is part of, may also be retrieved.

At step 220, a virtual image is displayed which is a composite of the image of the person shopping in step 205 and the image of the article of clothing. As previously discussed, a virtual masking of the image of the person with the article of clothing is one way that the virtual image can be produced.

The virtual image is typically a three-dimensional image, but a two dimensional image is also within the scope of the invention.

In addition, the display can prompt the shopper, after a certain amount of time, or at all times, as to whether he/she would like to see other variations of the article of clothing, or accessories and/or complimentary items. The person can browse and see oneself wearing different variations of a particular article of clothing, by any of, size, shape, texture, style, color, fabric, just to name a few possibilities.

FIG. 3 illustrates the optional step (230) of providing a prompt for the user to select additional articles of clothing which have been retrieved along with the first article of clothing (step 225). The number of articles retrieved can be set according to need, and the types of categories of clothing can be cross-referenced according to need as well. For example, if the retrieved article of clothing is a red dress, the same dress in white or blue can be retrieved. Similar dresses by the same designer may be retrieved, or similar dresses (According to, for example, color) can be retrieved. If the shade is a pastel, other pastel shades can be retrieved. The same would hold true for other patterns, such as stripes, plaid, paisley, etc.

FIG. 4 shows that at step 235 the prompting may include browsing for complimentary items or accessories, which can be prompted to the shopper. For example, if the shirt selected is green, white pants or green pants might be retrieved. However, orange pants might not be, as the combination of green and orange might not be popular with a majority of shoppers. accessories such as a hat or shoes might be prompted as well.

The database may also keep track of the particular shopper's past selections, and a series of trends can be identified, so that the most popular shirt that is sold with a particular type of pants would be displayed first. Conversely, the items could be categorized so that items which have not previously sold well are first displayed, in an effort to move the merchandise.

In addition, another feature of the present invention is that the system can provide the retailer with compiled data regarding which articles of clothing are being scanned. Thus, the retailer can see that most of the people browsing, even if they do not purchase, are, for example, a size 32 waist, or a certain percentage use virtual modeling of red dresses more than blue.

In addition, the compilation can provide the retailer with information about the number of variations tried by the shopper (e.g. there might be a trend of the average shopper to try five red dresses versus three blue dresses). This information is particularly useful to retailers because they could adjust their inventories accordingly to reflect these trends.

The quantity of times a particular article is displayed, and/or the frequency in which a particular article is displayed, can be valuable information to a retailer, or even a manufacturer. For example, the tendency of a number of people to try a certain color but not make a purchase might mean the color is pleasing but the individual items are not, and perhaps the decision to stock the same or similar color items having different styles, or from different manufacturers, could be made on the basis of the compile data. Also, the database may cross reference the prices, and whether or not an item is on sale could be factored in with how many times it was modeled.

It should be understood by persons of ordinary skill in the art that various modifications can be made to the system and method of the present invention which are within the spirit of the invention and the scope of the appended claims.

What is claimed is:

1. A system for virtual clothes modeling comprising:
means for obtaining a virtual image of a particular shopper;
means for scanning an identifying token which identifies predetermined information in a database associated with a first article of clothing; and
means for retrieving from the database the predetermined information corresponding to an image of the first article of clothing corresponding to the identifying token.

2. The system according to claim 1, further comprising
a display means for displaying the virtual image of the particular shopper and the first article of clothing being worn by the particular shopper.

3. The system according to claim 1, wherein said predetermined information of the first article of clothing includes its shape.

4. The system according to claim 1, wherein said predetermined information of the first article of clothing includes its color.

5. The system according to claim 1, wherein said predetermined information of the first article of clothing includes its texture.

6. The system according to claim 1, wherein said means for retrieval includes means for retrieving information corresponding to an image of a second article of clothing which is grouped into a category with said first article of clothing in said database.

7. The system according to claim 3, wherein said means for retrieval includes means for information corresponding to an image of a second article of clothing which is grouped into a category with said first article of clothing in said database.

8. The system according to claim 5, wherein said means for retrieval includes means for retrieving information corresponding to an image of a second article of clothing which is grouped into a category with said first article of clothing in said database.

9. The system according to claim 7, wherein said second article of clothing has a shape which is different than the shape of said first article of clothing.

10. The system according to claim 8, wherein said second article of clothing has a color which is different than the color of said first article of clothing.

11. The system according to claim 1, wherein said means for obtaining an image of a particular shopper comprises a camera.

12. The system according to claim 11, wherein said camera is three-dimensional.

13. The system according to claim 1, wherein said identifying token comprises bar coded information.

14. The system according to claim 1, wherein said identifying token includes ink seals.

15. The system according to claim 1, wherein said identifying token comprises an identification number which corresponds to the predetermined information.

16. The system according to claim 1, wherein said scanner comprises a bar coded scanner.

17. The system according to claim 1, wherein said scanner comprises a laser scanner.

18. The system according to claim 2, wherein said display means includes browsing means for displaying different items in the same category as the first article of clothing identified by the identifying token.

19. The system according to claim 4, wherein said display means includes browsing means for displaying different items in the same category as the first article of clothing identified by the identifying token.

20. The system according to claim 5, wherein said display means includes browsing means for displaying different items in the same category as the first article of clothing identified by the identifying token.

21. The system according to claim 2, wherein said means for retrieving further includes compiling at least one of a count and a frequency display of the first article of clothing on said display means over a predetermined period of time.

22. A method for virtual clothes modeling comprising the steps of:
(a) obtaining an image of a person;
(b) reading an identifying token which is associated with a first article of clothing;
(c) retrieving from a database a visual display of the first article of clothing corresponding the identifying token read in step (b); and
(d) displaying a virtual image of the person in step (a) and the first article of clothing as a combined image.

23. The method according to claim 22, wherein the image in step (a) is obtained by a camera.

24. The method according to claim 23, wherein the image obtained in step (a) comprises a three-dimensional image.

25. The method according to claim 22, wherein the identifying token read in step (b) comprises a bar coded label.

26. The method according to claim 22, wherein the identifying token read in step (b) comprises an ink seal.

27. The method according to claim 22, wherein the reading in step (b) is performed by a scanner.

28. The method according to claim 22, wherein the retrieving in step (c) includes retrieving identifying information from the database for at least a second article of clothing grouped into a category with the first article of clothing.

29. The method according to claim 28, wherein step (d) includes:
(i) providing a means for switching a display of the person wearing the first article of clothing to at least the second article of clothing; and
(ii) updating a counter in the database by at least one of a quantity and a frequency that the first article of clothing is displayed.

30. The method according to claim 29, wherein the grouping of the first article of clothing and at least the second article of clothing in the database is according to shape.

31. The method according to claim 29, wherein the grouping of the first article of clothing and at least the second article of clothing in the database is according to size.

32. The method according to claim 29, wherein the grouping of the first article of clothing and at least the second article of clothing in the database is according to texture.

33. The method according to claim 29, wherein the grouping of the first article of clothing and at least the second article of clothing in the database is according to color.

34. The method according to claim 33, wherein the first article of clothing and the second article of clothing are distinguishable only by color.

35. The method according to claim 33, wherein the first article of clothing and the second article of clothing are distinguishable only by size.

36. A method for virtual clothes modeling comprising the steps of:
(a) reading an identifying token which is associated with a first article of clothing;
(b) retrieving from a database an image of the first article of clothing corresponding the identifying token read in step (a);
(c) retrieving an image of a person stored in the database; and
(d) displaying a virtual image of the person in step (c) and the first article of clothing as a combination or the image of the person and the first article of clothing.

37. The method according to claim 36, wherein the combine image displayed in step (d) shows the person modeling the clothing.

38. The method according to claim 36, wherein the virtual image displayed in step (d) is combined by virtual masking.

39. The method according to claim 36, further comprising (e) providing a prompt on the display for a shopper to view at least second article of clothing as a combined image.

40. The method according to claim 39, wherein the prompt provided in step (e) includes a browsing option for complimentary items and accessories for one of the first article of clothing and the second article of clothing.
